(19) United States
(12) Patent Application Publication
(10) Pub. No.: US 2021/0092306 A1
(43) Pub. Date: Mar. 25, 2021

(54) MOVABLE BODY, IMAGE GENERATION METHOD, PROGRAM, AND RECORDING MEDIUM

(71) Applicant: SZ DJI TECHNOLOGY CO., LTD., Shenzhen (CN)

(72) Inventors: Jiemin ZHOU, Shenzhen (CN); Qingyu LU, Shenzhen (CN)

(21) Appl. No.: 16/950,461

(22) Filed: Nov. 17, 2020

Related U.S. Application Data
(63) Continuation of application No. PCT/CN2019/088775, filed on May 28, 2019.

(30) Foreign Application Priority Data
May 30, 2018 (JP) 2018-103758

(51) Int. Cl. H04N 5/265; H04N 5/235

(52) U.S. Cl. CPC H04N 5/265; H04N 5/2353

(57) ABSTRACT

A movable body includes a photographing device and a processor configured to obtain a moving speed of the movable body, instruct the photographing device to photograph a first image of a scene with a zoom magnification of the photographing device being fixed, obtain a second image of the scene with a varying zoom magnification larger than the fixed zoom magnification used for photographing the first image, determine a mixing ratio of the first image and the second image according to the moving speed of the movable body, and synthesize the first image and the second image based on the mixing ratio to generate a synthesized image.

### CROSS-REFERENCE TO RELATED APPLICATION

This application is a continuation of International Application No. PCT/CN2019/088775, filed May 28, 2019, which claims priority to Japanese Application No. 2018-103758, filed May 30, 2018, the entire contents of both of which are incorporated herein by reference.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to a movable body, an image generation method, a program, and a recording medium.

### BACKGROUND

In the past, people usually uses image-editing software (including Photoshop®) and personal computers (PC) to perform manual operations via input devices (such as a mouse) for editing photographed images, such that a high-speed movement effect is applied to the photographed images (see Non-Patent Reference 1). The effect uses blur (movement) to provide realism to the images. For example, for a photographed image of a motorcycle, a range of the motorcycle is selected and a motorcycle layer is formed. Subsequently, two backgrounds except the motorcycle are copied to form a background layer. “Filter” 4 “Blur” 4 “Move” are applied to the background layer such that a direction of the movement is aligned with a travel direction of the motorcycle and an appropriate distance is given. Then the motorcycle layer slides slightly along the movement direction to achieve the effect. In this high-speed movement effect, blur (movement) is applied to the background. It is also possible to apply blur (movement) to the motorcycle.

The user needs to manually operate a PC while applying an effect. For example, the user need to edit the image while finely adjusting the position of the subject to be photographed before and after the movement to obtain an image with a high-speed movement effect. The user's operation becomes cumbersome the error operation can easily happen.

### Non-Patent Reference

Non-Patent Reference 1: “Photoshop technologies”,” [online], accessed May 11, 2018, http://photoshop76.blog.fc2.com/blog-entry-29.html.

### SUMMARY

One aspect of the present disclosure provides a movable body including a photographing device and a processor configured to obtain a moving speed of the movable body, instruct the photographing device to photograph a first image of a scene with a zoom magnification of the photographing device being fixed, obtain a second image of the scene with a varying zoom magnification larger than the fixed zoom magnification used for photographing the first image, determine a mixing ratio of the first image and the second image according to the moving speed of the movable body, and synthesize the first image and the second image based on the mixing ratio to generate a synthesized image.

Another aspect of the present disclosure provides an image generation method including obtaining a moving speed of a movable body, photographing, through a photographing device of the movable body, a first image of a scene with a zoom magnification of the photographing device being fixed, obtaining a second image of the scene with a varying zoom magnification larger than the fixed zoom magnification used for photographing the first image, determining a mixing ratio of the first image and the second image according to the moving speed of the movable body, and synthesizing the first image and the second image based on the mixing ratio to generate a synthesized image.

Another aspect of the present disclosure provides a computer-readable storage medium storing a program that, when executed by a processor, causes the processor to obtain a moving speed of a movable body, photograph, through a photographing device of the movable body, a first image of a scene with a zoom magnification of the photographing device being fixed, obtain a second image of the scene with a varying zoom magnification larger than the fixed zoom magnification used for photographing the first image, determine a mixing ratio of the first image and the second image according to the moving speed of the movable body, and synthesize the first image and the second image based on the mixing ratio to generate a synthesized image.

### BRIEF DESCRIPTION OF THE DRAWINGS

FIG. 1 illustrates an exemplary structure of an aerial object system consistent with various embodiments of the present disclosure.

FIG. 2 illustrates another exemplary structure of an aerial object system consistent with various embodiments of the present disclosure.

FIG. 3 illustrates an exemplary unmanned aerial vehicle consistent with various embodiments of the present disclosure.

FIG. 4 illustrates an exemplary hardware structure of an unmanned aerial vehicle consistent with various embodiments of the present disclosure.

FIG. 5 illustrates an exemplary hardware structure of a terminal consistent with various embodiments of the present disclosure.

FIG. 6 illustrates an exemplary hardware structure of a photographing device consistent with various embodiments of the present disclosure.

FIG. 7 illustrates an example of a range of a zoom magnification corresponding to flight speed of the unmanned aerial vehicle consistent with various embodiments of the present disclosure.

FIG. 8 illustrates an exemplary synthesized image obtained by synthesizing two photographed images photographed by the photographing device consistent with various embodiments of the present disclosure.

FIG. 9 illustrates an example of a change of a combination ratio corresponding to a distance to a center of the photographed image consistent with various embodiments of the present disclosure.

FIG. 10 illustrates an exemplary photographing operation of an aerial object consistent with various embodiments of the present disclosure.

FIG. 11 illustrates an exemplary synthesized image formed by applying a high-speed flying effect consistent with various embodiments of the present disclosure.

FIG. 12 is a diagram for explaining forming a synthesized image based on a photographed image consistent with various embodiments of the present disclosure.

### LIST OF REFERENCE NUMERALS

| | |
|---|---|
| 10 | aerial object system |
| 11 | camera processor |
| 12 | shutter |
| 13 | imaging device |
| 14 | imaging processor |
| 15 | memory |
| 18 | flash |
| 19 | shutter driver |
| 20 | device driver |
| 21 | gain controller |
| 32 | ND filter |
| 33 | aperture |
| 34 | lens group |
| 36 | lens driver |
| 38 | ND driver |
| 40 | aperture driver |
| 80 | terminal |
| 81 | terminal controller |
| 83 | operation unit |
| 85 | communication circuit |
| 87 | memory |
| 88 | display |
| 89 | storage device |
| 100 | unmaned aerial vehicle |
| 110 | UAV controller |
| 150 | communication interface |
| 160 | memory |
| 170 | storage device |
| 200 | gimbal |
| 210 | rotor mechanism |
| 220, 230 | photographing device |
| 220z | housing |
| 240 | GPS receiver |
| 250 | inertial measurement unit |
| 260 | magnetic compass |
| 270 | barometric altimeter |
| 280 | ultrasonic sensor |
| 290 | laser measurement devie |
| op | optical axis |

### DETAILED DESCRIPTION OF THE EMBODIMENTS

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

Example embodiments will be described with reference to the accompanying drawings, in which the same numbers refer to the same or similar elements unless otherwise specified.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them. The terms “perpendicular,” “horizontal,” “left,” “right,” and similar expressions used herein are merely intended for description.

Unless otherwise defined, all the technical and scientific terms used herein have the same or similar meanings as generally understood by one of ordinary skill in the art. As described herein, the terms used in the specification of the present disclosure are intended to describe example embodiments, instead of limiting the present disclosure. The term “and/or” used herein includes any suitable combination of one or more related items listed.

In following embodiments of the present disclosure, an unmanned aerial vehicle is used as an example of a movable body for illustrative purposes only and should not limit the scope of the present disclosure. The unmanned aerial vehicle may include an aerial vehicle movable in the air. In the drawings of the application, the unmanned aerial vehicle is marked as “UAV.” An image generation method may specify the movement of the movable body. A storage medium may store a program (such as a program that causes the movable body to execute various processes).

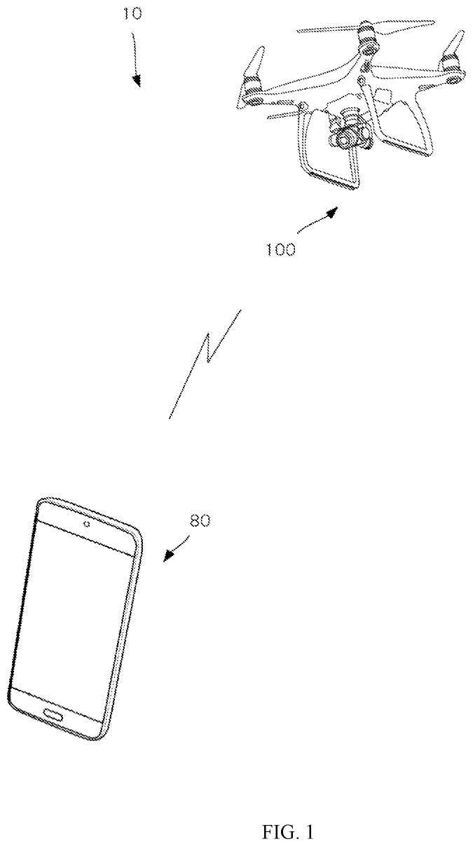

FIG. 1 illustrates an exemplary aerial object system 10 according to an embodiment of the present disclosure. The aerial object system 10 includes an unmanned aerial vehicle 100 and a terminal 80. The unmanned aerial vehicle 100 and the terminal 80 may communicate with each other through wired communication or wireless communication such as wireless local area network (LAN). For illustrative purposes only, the embodiment in FIG. 1, where the terminal 80 is a portable terminal such as a smartphone or a tablet terminal is used as an example, and should not limit the scope of the present disclosure.

In another embodiment, the aerial object system may include an unmanned aerial vehicle, a transmitter (such as a ratio controller), and a portable terminal. Correspondingly, a user may use a joystick disposed on the front of the transmitter to control the flight of the unmanned aerial vehicle. Further, the unmanned aerial vehicle, the transmitter, and the portable terminal may communicate with each other through wired communication or wireless communication.

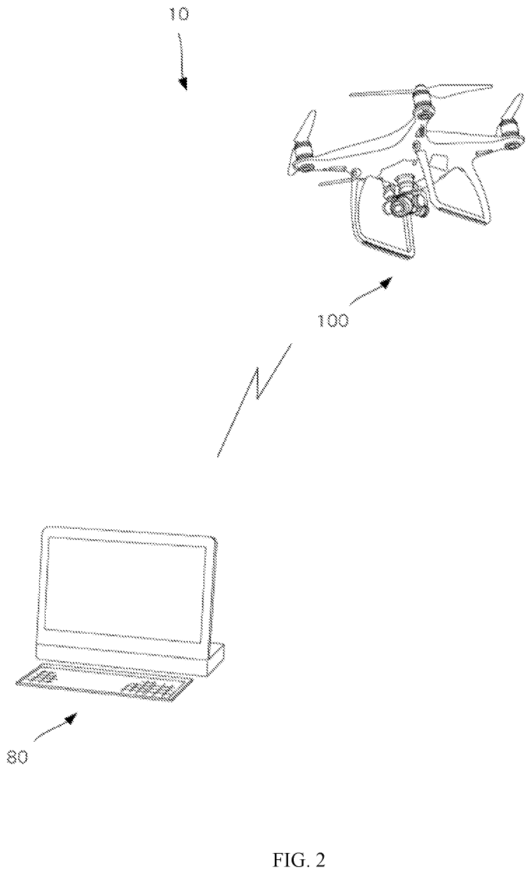

FIG. 2 illustrates another example of the aerial object system 10 according to another embodiment of the present disclosure. In the embodiment illustrated in FIG. 2, the terminal 80 is a personal computer. Functions of the terminal 80 in the embodiment shown in FIG. 1 and the embodiment shown in FIG. 2 may be the same.

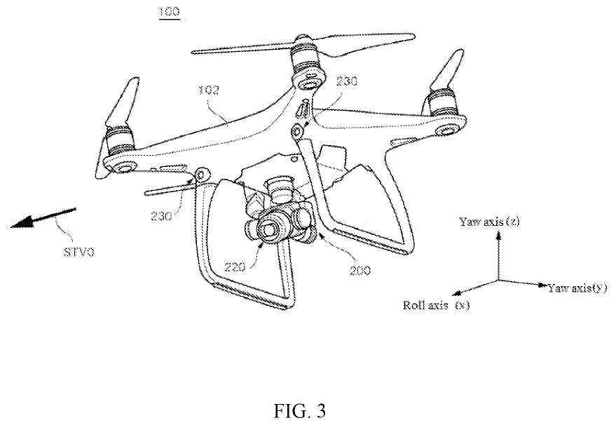

FIG. 3 illustrates an example appearance of the unmanned aerial vehicle 100. In FIG. 3, a perspective view of the unmanned aerial vehicle 100 flying along a movement direction STV0 is shown. In embodiments of the present disclosure, the unmanned aerial vehicle is used as an example of the movable body for illustrative purposes only and should not limit the scope of the present disclosure.

As illustrated in FIG. 3, a roll axis (denoted an x-axis) is disposed parallel to the ground and along the movement direction STV0. In this condition, a pitch axis (denoted as a y-axis) is disposed parallel to the ground and perpendicular to the roll axis. Further, a yaw axis (denoted as a z-axis) is disposed perpendicular to the ground and perpendicular to the pitch axis.

The unmanned aerial vehicle 100 includes a UAV body 102, a gimbal 200, a first photographing device 220, and a plurality of second photographing devices 230.

The UAV body 102 includes a plurality of rotors (propellers). The UAV body 102 enables the unmanned aerial vehicle 100 to fly by controlling the rotation of the plurality of rotors. In one embodiment, for example, the UAV body 102 may use four rotors to enable the unmanned aerial vehicle 100 to fly. For illustrative purposes only, the embodiment with four rotors is used as an example, and should not limit the number of rotors and the scope of the present disclosure. In some embodiments, the unmanned aerial vehicle 100 may be a fixed wing aircraft without rotors.

The first photographing device 220 may be a photographing camera for photographing an object to be photographed (also referred to as a “photographing target” or simply “target,” such as sky scene, mountain scene, rivers scene, a building on the ground) in an expected photographing range.

The plurality of second photographing devices 230 may be sensor cameras for photographing surroundings of the unmanned aerial vehicle 100 to control the flight of the unmanned aerial vehicle 100. Two second photographing devices 230 of the plurality of second photographing devices 230 may be disposed at a vehicle nose (that is, a front) of the unmanned aerial vehicle 100. Other two second photographing devices 230 of the plurality of second photographing devices 230 may be disposed at a bottom of the unmanned aerial vehicle 100. The two second photographing devices 230 at the front may be paired to function as a so-called stereo camera, and the two second photographing devices 230 at the bottom may be also paired to function as another stereo camera. Three-dimensional space data (three-dimensional shape data) around the unmanned aerial vehicle 100 may be generated according to images photographed by the plurality of second photographing devices 230. For illustrative purposes only, the embodiment in FIG. 3 with four second photographing devices 230 is used as an example, and should not limit the scope of the present disclosure. In various embodiments, a number of the plurality of second photographing devices 230 may be different from 4, as long as the unmanned aerial vehicle has at least one second photographing devices 230. For example, in another embodiment, the unmanned aerial vehicle 100 may include at least one second photographing device 230 at each of the nose, a tail, a side, a bottom, and a top of the unmanned aerial vehicle. A view angle of a second photographing device 230 may be larger than a view angle of the first photographing device 220. A second photographing devices 230 may include a single focus lens or fisheye lens.

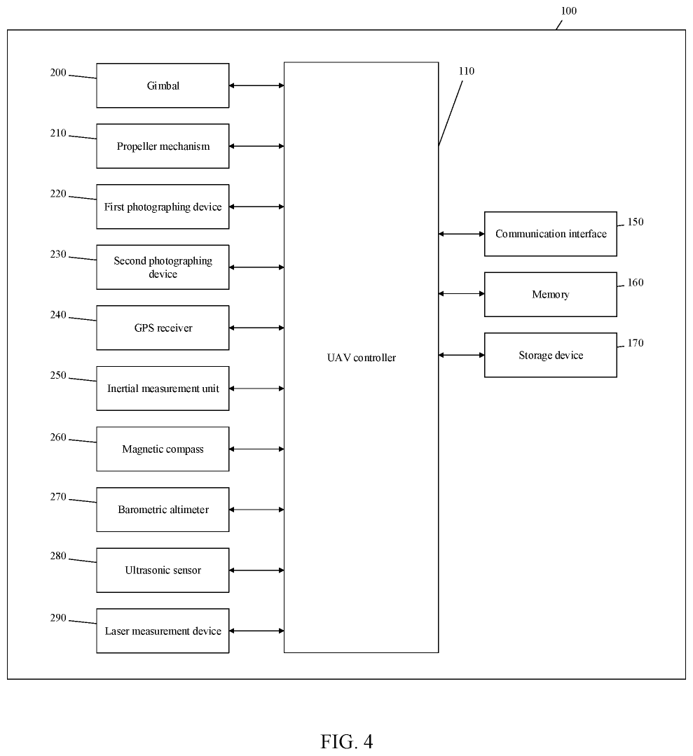

FIG. 4 illustrates an exemplary hardware structure of the unmanned aerial vehicle 100. The unmanned aerial vehicle 100 includes a UAV controller 110, a communication interface 150, a memory 160, a storage device 170, the gimbal 200, a propeller mechanism 210, the first photographing device 220, the plurality of second photographing devices 230, a GPS receiver 240, an inertial measurement unit (IMU) 250, a magnetic compass 260, a barometric altimeter 270, an ultrasonic sensor 280, and a laser measurement device 290.

The UAV controller 110 may include a central processing unit (CPU), a micro processing unit (MPU), or a digital signal processor (DSP). The UAV controller 110 may be configured to perform signal processing for overall control of actions of various parts of the unmanned aerial vehicle 100, input/output processing with other parts, calculating processing of data, or storage processing of the data. The UAV controller 110 may be an example of a processor.

The UAV controller 110 may be configured to control the flight of the unmanned aerial vehicle 100 according to a program stored in the memory 160. In some other embodiment, the UAV controller 110 may be configured to control the flight and to aerially photograph images.

The UAV controller 110 may obtain position information indicating the position of the unmanned aerial vehicle 100. In one embodiment, the UAV controller 110 may obtain position information indicating a latitude, a longitude, or an altitude where the unmanned aerial vehicle 100 is located from the GPS receiver 240. In another embodiment, the UAV controller 110 may obtain latitude and longitude information indicating the latitude and longitude of the unmanned aerial vehicle 100 from the GPS receiver 240, and obtain altitude information indicating the altitude of the unmanned aerial vehicle 100 from the barometric altimeter 270, as position information. In another embodiment, the UAV controller 110 may obtain a distance between a radiation point of ultrasonic wave generated by the ultrasonic sensor 280 and a reflection point of the ultrasonic wave as height information.

The UAV controller 110 may obtain orientation information indicating an orientation of the unmanned aerial vehicle 100 from the magnetic compass 260. The orientation information may be represented by an orientation corresponding to the orientation of the nose of the unmanned aerial vehicle 100, for example.

The UAV controller 110 may obtain position information corresponding to the position that the unmanned aerial vehicle 100 should exist when the first photographing device 220 photographs a photographing range to be photographed. In one embodiment, the UAV controller 110 may obtain the position information corresponding to the position that the unmanned aerial vehicle 100 should exist from the memory 160. In another embodiment, the UAV controller 110 may obtain the position information corresponding to the position that the unmanned aerial vehicle 100 should exist from other devices through the communication interface 150. In some embodiment, the UAV controller 110 may determine the position that the unmanned aerial vehicle 100 could exist according to a three-dimensional map database, and obtain the position as the position information corresponding to the position that the unmanned aerial vehicle 100 should exist.

The UAV controller 110 may obtain photographing range information indicating photographing ranges of the first photographing device 220 and the plurality of second photographing devices 230 respectively. The UAV controller 110 may obtain view angle information indicating view angles of the first photographing device 220 and the plurality of second photographing devices 230 respectively from the first photographing device 220 and the plurality of second photographing devices 230, and use the view angle information as parameters to configure the photographing ranges. The UAV controller 110 may obtain information indicating photographing directions of the first photographing device 220 and the plurality of second photographing devices 230 respectively, and use that information as parameters to configure the photographing ranges. The UAV controller 110 may obtain attitude information indicating attitude status of the first photographing device 220 from the gimbal 200, and use the attitude information as the information indicating photographing directions of the first photographing device 220. The attitude information indicating attitude status of the first photographing device 220 may represent rotation angles of the pitch axis and the yaw axis of the gimbal 200 from reference rotation angles.

The UAV controller 110 may obtain the position information indicating the position of the unmanned aerial vehicle 100 as a parameter for specifying the photographing range. The UAV controller 110 can obtain the photographing range information by setting the photographing range representing the geographic range captured by the first photographing device 220 and generating the photographing range information according to the view angles and photographing directions of the first photographing device 220 and the plurality of second photographing devices 230, and the location of the unmanned aerial vehicle 100.

In one embodiment, the UAV controller 110 may obtain the photographing range information from the memory 160. In another embodiment, the UAV controller 110 may obtain the photographing range information through the communication interface 150.

The UAV controller 110 may control the gimbal 200, the propeller mechanism 210, the first photographing device 220, and the plurality of second photographing device 230. In one embodiment, the UAV controller 110 may control the photographing range of the first photographing device 220 by adjusting the photographing direction or the view angle of the first photographing device 220. In another embodiment, the UAV controller 110 may control the photographing range of the first photographing device 220 supported by the gimbal 200 by adjusting a rotation mechanism of the gimbal 200.

The photographing range may be the geographic range photographed by the first photographing device 220 or the plurality of second photographing devices 230. In one embodiment, the photographing range may be a range of three-dimensional spatial data defined by latitude, longitude, and altitude. In another embodiment, the photographing range may be a range of two-dimensional spatial data defined by latitude and longitude. The photographing range may be determined based on the view angles and photographing directions of the first photographing device 220 and the plurality of second photographing devices 230, and the location of the unmanned aerial vehicle 100. In one embodiment, the photographing directions of the first photographing device 220 and the plurality of second photographing devices 230 may be defined according to azimuth and depression angle of fronts of photographing lenses of the first photographing device 220 and the plurality of second photographing devices 230. In another embodiment, the photographing directions of the first photographing device 220 may be defined according to an orientation of the nose of the unmanned aerial vehicle 100 and the attitude status of the first photographing device 220 for the gimbal 200. In another embodiment, the photographing directions of the plurality of second photographing devices 230 may be determined by the orientation of the nose of the unmanned aerial vehicle 100 and position where the plurality of second photographing devices 230 are disposed.

The UAV controller 110 may determine the environment surrounding the unmanned aerial vehicle 100 by analyzing a plurality of images captured by the plurality of second photographing devices 230. The UAV controller 110 may control the flight of the unmanned aerial vehicle 100 according to the environment surrounding the unmanned aerial vehicle 100, such as avoiding obstacles.

The UAV controller 110 may obtain stereo information (three-dimensional information) indicating stereo shapes (three-dimensional shapes) of objects existing around the unmanned aerial vehicle 100. The objects may include, for example, a part of a landscape such as buildings, roads, vehicles, and trees. The stereo information may be, for example, three-dimensional spatial data. The UAV controller 110 may obtain the stereo information from each image obtained by the plurality of second photographing devices 230, by generating stereo information indicating the stereo shapes of the objects existing around the unmanned aerial vehicle 100. In another embodiment, the UAV controller 110 may obtain three-dimensional information indicating the three-dimensional shapes of the objects existing around the unmanned aerial vehicle 100 by referring to a three-dimensional map database stored in the memory 160 or the storage device 170. In another embodiment, the UAV controller 110 may obtain three-dimensional information related to the three-dimensional shapes of the objects existing around the unmanned aerial vehicle 100 by referring to a three-dimensional map database managed by a server existing on the network.

The UAV controller 110 may control the flight of the unmanned aerial vehicle 100 by controlling the propeller mechanism 210. That is, the UAV controller 110 may control the position including the latitude, longitude, and altitude of the unmanned aerial vehicle 100 by controlling the propeller mechanism 210. The UAV controller 110 may control the photographing range of the first photographing device 220 by controlling the flight of the unmanned aerial vehicle 100. The UAV controller 110 may control the view angle of the first photographing device 220 by controlling a zoom lens included in the first photographing device 220. The UAV controller 110 may use the digital zoom function of first photographing device 220 to control the view angle of first photographing device 220 through digital zoom.

In one embodiment, the first photographing device 220 may be fixed to the unmanned aerial vehicle, and cannot be moved. Correspondingly, the UAV controller 110 may control the unmanned aerial vehicle 100 to move to a designated position on a designated date, such that the first photographing device 220 may photograph a desired photographing range in a desired environment. In another embodiment, the first photographing device 220 may not include a zoom function, and the view angle of the first photographing device 220 cannot be changed. Correspondingly, the UAV controller 110 may control the unmanned aerial vehicle 100 to move to a designated position on a designated date, such that the first photographing device 220 may photograph a desired photographing range in a desired environment.

The communication interface 150 may be configured to communicate with the terminal 80. In some embodiments, the communication interface 150 may use any wireless communication methods to achieve wireless communication. In some other embodiments, the communication interface 150 may use any wired communication methods to achieve wired communication. The communication interface 150 may transmit the aerial photographing images and additional information (metadata) related to the aerial photographing images to the terminal 80.

The memory 160 may be configured to store programs required by the UAV controller 110 to control the gimbal 200, the rotor mechanism 210, the first photographing device 220, the plurality of second photographing device 230, the GPS receiver 240, the inertial measurement unit 250, the magnetic compass 260, the barometric altimeter 270, the ultrasonic sensor 280, and the laser measurement device 290. The memory 160 may be a computer-readable recording medium, and may include at least one of Static Random Access Memory (SRAM), Dynamic Random Access Memory (DRAM), Erasable Programmable Read-Only Memory (EPROM), Electrically Erasable Programmable Read-Only Memory (EEPROM), or Universal Serial Bus (USB) memory. The memory 160 may be detachable from the unmanned aerial vehicle 100. The memory 160 may work as a memory for operations.

The storage device 170 may include at least one of Hard Disk Drive (HDD), Solid State Drive (SSD), SD memory card, USB memory, or other storage devices. The storage device 170 may be configured to store various information and various data. The storage device 170 may be detachable from the unmanned aerial vehicle 100, and may store aerial photographing images.

The gimbal 200 may be configured to rotatably support the first photographing device 220 with the yaw axis, the pitch axis, and the roll axis as rotation centers. The gimbal 200 may be configured to make the first photographing device 220 rotatable about at least one of the yaw axis, the pitch axis, or the roll axis, therefore to adjust the photographing direction of the first photographing device 220.

The propeller mechanism 210 may include a plurality of propellers and a plurality of driving motors for driving the plurality of propellers to rotate. The propeller mechanism 210 may control the rotation through the UAV controller 110, to make the unmanned aerial vehicle 100 fly. In one embodiment, a number of the plurality of propellers may be four. In some other embodiments, the number of the plurality of propellers may be another suitable number. In some embodiments, the unmanned aerial vehicle 100 may be a fixed-wing aircraft without propellers.

The first photographing device 220 may photograph subjects to be photographed in the desired photographing range to generate photographing image data. The photographing image data generated by the first photographing device 220 (including aerial photographing images) may be stored a memory in the first photographing device 220 or in the storage device 170.

The plurality of second photographing devices 230 may be configured to photograph environment of the unmanned aerial vehicle 100 to generate photographing image data. The photographing image data of the plurality of second photographing devices 230 may be stored in the storage device 170.

The GPS receiver 240 may be configured to receive a plurality of signals indicating the time transmitted from a plurality of navigation satellites (that is, GPS satellites) and the position (coordinate) of each of the plurality of GPS satellite. The GPS receiver 240 may be configured to further calculate the position of the GPS receiver 240 (that is, the position of the unmanned aerial vehicle 100) based on the received plurality of signals. The GPS receiver 240 may output the position information of the unmanned aerial vehicle 100 to the UAV controller 110. In another embodiment, the UAV controller 110 instead of the GPS receiver 240 may be configured to calculate the position information of the GPS receiver 240. In this embodiment, the information indicating the time and the position of each of the plurality of GPS satellites included in the plurality of signals received by the GPS receiver 240, may be inputted to the UAV controller 110.

The inertial measurement unit 250 may be configured to detect the attitude of the unmanned aerial vehicle 100 and output the detected results to the UAV controller 110. The inertial measurement unit 250 may detect acceleration of the unmanned aerial vehicle 100 in the three-axis directions of front/rear, left/right, and up/down, and angular velocities of the pitch axis, the roll axis, and the yaw axis, as the attitude of the unmanned aerial vehicle 100.

The magnetic compass 260 may be configured to detect the position of the nose of the unmanned aerial vehicle 100 and output the detected results to the UAV controller 110.

The barometric altimeter 270 may be configured to detect the flying altitude of the unmanned aerial vehicle 100 and output the detected results to the UAV controller 110.

The ultrasonic sensor 280 may be configured to emit ultrasonic waves, detect ultrasonic waves reflected by the ground and objects, and output the detected results to the UAV controller 110. The detected results may indicate a distance from the unmanned aerial vehicle 100 to the ground, that is, the height. The detected results may further indicate a distance from the unmanned aerial vehicle 100 to an object (a subject to be photographed).

The laser measurement device 290 may be configured to emit laser light towards the object, receive reflected light reflected by the object, and measure a distance between the unmanned aerial vehicle 100 and the object (a subject to be photographed) through the reflected light. As an example of a laser-based distance measurement method, a time-of-flight method may be used.

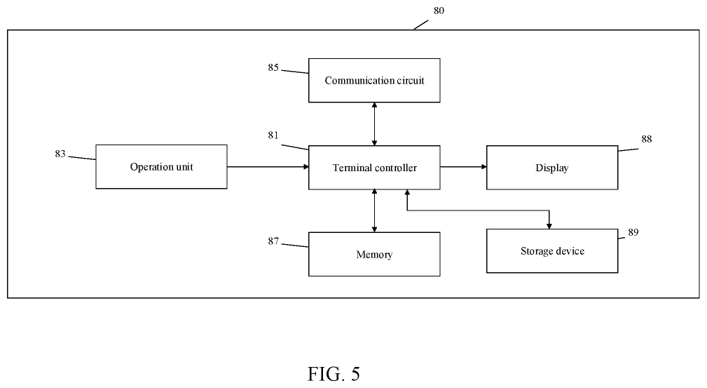

FIG. 5 illustrates an exemplary hardware structure of the terminal 80 consistent with the present disclosure. As illustrated in FIG. 5, the terminal 80 includes a terminal controller 81, an operation unit 83, a communication circuit 85, a memory 87, a display 88, and a storage device 89. The terminal 80 may be held by a user intending to instruct the flight control of the unmanned aerial vehicle 100.

The terminal controller 81 may include CPU, MPU, or DSP. The terminal controller 81 may be configured to overall control signal processing of operations of each unit of the terminal 80, data input/output processing with other units, calculating processing of data, or storage processing of data.

The terminal controller 81 may obtain data or information from the unmanned aerial vehicle 100 through the communication circuit 85. The terminal controller 81 may also obtain data or information inputted through the operation unit 83. The terminal controller 81 may also obtain data or information stored in the memory 87. The terminal controller 81 may transmit data or information to the unmanned aerial vehicle 100 through the communication circuit 85. The terminal controller 81 may transmit data or information to the display 88, such that the display 88 displays display information based on the data or the information.

The terminal controller 81 may be configured to execute application programs for synthesizing images and generating synthesized images. The terminal controller 81 may also be configured to generate various data used in the application programs.

The operation unit 83 may receive and obtain data or information inputted by the user of the terminal 80. The operation unit 83 may also be provided with input devices including buttons, keys, a touch screen, or a microphone. For illustrative purposes only, the embodiment where the operation unit 83 and the display 88 include a touch screen is used as an example, and should not limit the scope of the present disclosure. In the present embodiment, the operation unit 83 may receive touch operations, click operations, drag operations, or other operations. The information input by the operation unit 83 may be transmitted to the unmanned aerial vehicle 100.

The communication circuit 85 may perform wireless communication with the unmanned aerial vehicle 100 through various wireless communication methods. The wireless communication methods of this wireless communication may include, for example, communication via wireless LAN, Bluetooth®, or public wireless line. In other embodiments, the communication circuit 85 may perform wired communication by any wired communication methods.

The memory 87 may include, for example, a ROM that stores a program that defines the operation of the terminal 80 and data of set values, or a RAM that temporarily stores various information or data used when the terminal controller 81 performs processing. In some other embodiment, the memory 87 may include a memory other than ROM and RAM. In one embodiment, the memory 87 may be disposed inside the terminal 80. In other embodiments, the memory 87 may be configured to be detachable from the terminal 80. Programs may include application programs.

The display 88 may include a liquid crystal display (LCD) and may be configured to display various information or data outputted from the terminal controller 81. The display 88 may display various data or information related to the execution of the application programs.

The storage device 89 may be configured to store and save various data and/or information. The storage device 89 may be HDD, SSD, SD card, USB memory, etc. In one embodiment, the storage device 89 may be disposed inside the terminal 80. In other embodiments, the storage device 89 may be configured to be detachable from the terminal 80. The storage device 89 may store aerial photographing images and additional information obtained from the unmanned aerial vehicle 100. Additional information may also be stored in the memory 87.

In one embodiment, the aerial object system 10 may include the transmitter (the ratio controller). Correspondingly, the process executed by the terminal 80 may also be executed by the transmitter. In various embodiments, the transmitter may have a same structure as the terminal 80. For example, in one embodiment, the transmitter may include a controller, an operation unit, a communication circuit, a display, and/or a memory. In some embodiments where the aerial object system 10 may include the transmitter, the terminal 80 may not be needed.

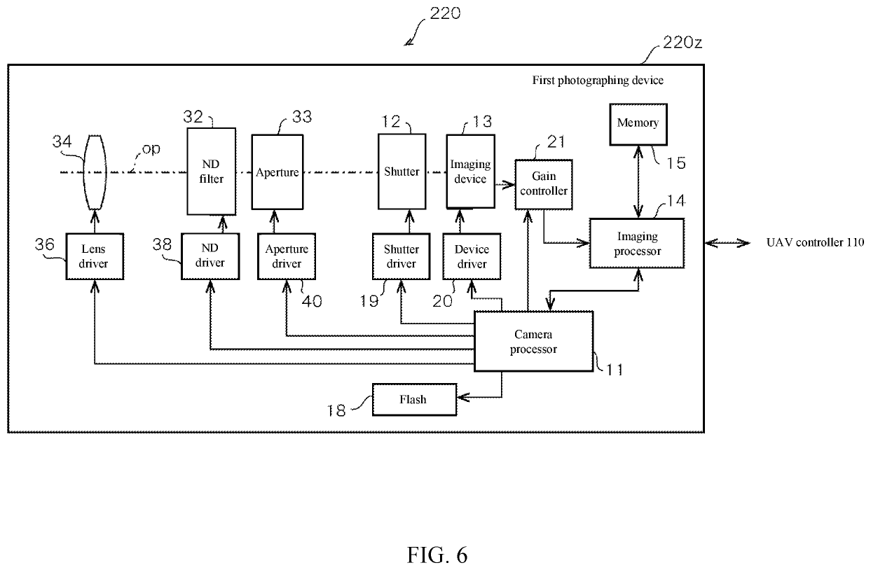

FIG. 6 illustrates an exemplary hardware structure of the first photographing device 220 of the unmanned aerial vehicle 100. The first photographing device 220 includes a housing 220z. Inside the housing 220z, the first photographing device 220 further includes a camera processor 11, a shutter 12, an imaging device 13, an imaging processor 14, a memory 15, a shutter driver 19, a device driver 20, a gain controller 21, and a flash 18. In some embodiments, the first photographing device 220 may not include at least one of the above components.

The camera processor 11 may be configured to determine shooting conditions including exposure time and/or aperture (diaphragm). Considering the amount of light reduction caused by a neutral density (ND) filter 32, the camera processor 11 may perform exposure (AE: Automatic Exposure) control. The camera processor 11 may calculate a brightness level (for example, a pixel value) based on image data outputted from the image processor 14. The camera processor 11 may calculate the gain value of the imaging device 13 based on the calculated brightness level, and send the calculation result to the gain controller 21. The camera processor 11 may calculate a shutter speed value for opening and closing the shutter 12 based on the calculated brightness level, and send the calculation result to the shutter driver 19. The camera processor 11 may send a shooting instruction to the device driver 20 such that the device driver 20 provides a timing signal to the imaging device 13.

In one embodiment, the shutter 12 may be a focal plane shutter, and may be driven by the shutter driver 19. When the shutter 12 opens, incident light may form an image on an imaging surface of the imaging device 13. The imaging device 13 may photoelectrically convert the optical image formed on the imaging surface, and output it as an image signal. The imaging device 13 may include a Charge Coupled Device (CCD) image sensor or a Complementary Metal Oxide Semiconductor (CMOS) image sensor.

The gain controller 21 may be configured to reduce the noise of the image signal inputted from the imaging device 13 and control the gain of the amplified imaging signal. The image processor 14 may be configured to perform analog-to-digital conversion on the imaging signal amplified by the gain controller 21 to generate image data. The image processor 14 may perform various processes including shading correction, color correction, contour enhancement, noise removal, gamma correction, debayering, or compression.

The memory 15 may be a storage medium for storing various data or image data. For example, in one embodiment, the memory 15 may be configured to store exposure control information for calculating the exposure amount based on the shutter speed S, F value, ISO sensitivity, and ND value. The ISO sensitivity may be a value corresponding to gain. The ND value may represent the degree of dimming caused by the use of a dimming filter.

The shutter driver 19 may be configured to open or close the shutter 12 at a shutter speed instructed by the camera processor 11.

The device drive unit 20 may be a timing generator that provides a timing signal to the imaging device 13 in accordance with a shooting instruction from the camera processor 11 and performs charge accumulation operations, readout operations, or reset operations of the imaging device 13.

The flash 18 may be configured to flash to illuminate the subject when photographing at night or at backlit according to the instruction of the camera processor 11. In one embodiment, the flash 18 may be a light-emitting diode (LED) lamp. In some other embodiment, the flash 18 may be omitted.

In the housing 220z, the first photographing device 220 further includes the ND filter 32, an aperture 33, a lens group 34, a lens driver 36, an ND driver 38, or an aperture driver 40.

The lens group 34 may converge light from the subject to be photographed and form an image on the imaging device 13. The lens group 34 may include a focus lens, a zoom lens, a lens for image shake correction, or other lenses. The lens group 34 may be driven by the lens driver 36. The lens driver 36 may include a motor (not shown). With respect to a control signal from the camera processor 11 inputted to the lens driver 36, the lens driver 36 may drive the lens group 34 including the zoom lens and the focus lens move in the direction of the optical axis op (optical axis direction). When the lens driver 36 performs a zoom operation that moves the zoom lens to change the zoom magnification, a lens barrel that is a part of the housing 220z and accommodates the lens group 34 may be expanded and contracted in the front-rear direction.

The aperture 33 may be driven by the aperture driver 40. The aperture driver 40 may include a motor (not shown), and may drive an opening of the aperture 33 to be enlarged or reduced with respect to a control signal from the camera processor 11.

In one embodiment, the ND filter 32 may be disposed close to the aperture 33 along the direction of the optical axis op (optical axis direction), and may be configured to perform a light reducing process for reducing the amount of incident light. The ND driver 38 may include a motor (not shown), and may insert the ND filter 32 into or remove the ND filter 32 from the optical axis op with respect to a control signal from the camera processor 11 inputted to the ND driver 38.

The UAV controller 110 of the unmanned aerial vehicle 100 may have functions related to image generation. The UAV controller 110 may be an example of the processor. The UAV controller 110 may perform processing related to the synthesis of photographed images, thereby applying a moving effect at a speed exceeding the flight speed of the unmanned aerial vehicle 100 (hereinafter also referred to as a high-speed flight effect) and generating a realistic image. The UAV controller 110 may apply a high-speed flight effect based on a photographed image taken during the stop of the unmanned aerial vehicle 100 (for example, hovering).

The UAV controller 110 may be configured to set an operation mode of the unmanned aerial vehicle 100, for example, including a flight mode or a photographing mode. The photographing mode may include a hyper-speed photographing mode which is used to apply a high-speed flight effect to a photographed image captured by the first photographing device 220. In one embodiment, the operation mode of the unmanned aerial vehicle 100 (for example, the hyper-speed photographing mode) may be instructed by the UAV controller 110 of the unmanned aerial vehicle 100 based on the time period and the location of the unmanned aerial vehicle 100, or may be instructed by the terminal 80 remotely through the communication interface 150.

The UAV controller 110 may obtain at least one photographed image captured by the first photographing device 220. The UAV controller 110 may photograph and obtain a first image Ga with a predetermined exposure through the first photographing device 220. The exposure amount may be determined based on at least one of the shutter speed, aperture, ISO sensitivity, ND value, etc., for example. The amount of exposure when the first image Ga is taken may be arbitrary, and may be 0 EV, for example. The zoom magnification of the first photographing device 220 when photographing the first image Ga may be arbitrary, and may be 1.0, for example. The exposure time corresponding to the shutter speed of the first photographing device 220 when the first image Ga is taken may be, for example, 1/30 second. During one photographing, the zoom magnification may be fixed when the first image Ga is photographed. Since the first image Ga is basically and general photographing, it may be also called a normal image.

The UAV controller 110 may photograph and obtain a second image Gb through the first photographing device 220 with a predetermined exposure amount. The exposure level when the second image Gb is captured may be the same as the exposure level when the first image Ga is captured, for example, it may be 1.0. By making the exposure amounts of the first image Ga and the second image Gb same to each other, adjustment may be made so that the brightness of the first image Ga and the second image Gb does not change. Also, the shutter speed when the second image Gb is taken may be equal to or less than the shutter speed when the first image Ga is taken. That is, the exposure time when the second image Gb is taken may be longer than or equal to the exposure time when the first image Ga is taken, for example, 1 second. Also, even if the exposure levels of the first image Ga and the second image Gb do not change, when the exposure time when the second image Gb is taken is longer than the exposure time when the first image Ga is taken, other photographing parameters (for example, aperture, ISO sensitivity, ND value) may be adjusted appropriately. In one embodiment, the UAV controller 110 may store the information of the photographing parameters in the memory 160, or may store it in the memory 15 through the camera processor 11 of the first photographing device 220.

In the second image Gb, the zoom magnification may be changed during one photographing. The change range of the zoom magnification may be arbitrary, but the zoom magnification may be greater than or equal to the zoom magnification when the first image Ga is taken. The UAV controller 110 may determine the change range of the zoom magnification of the first photographing device 220 for photographing the second image Gb. The UAV controller 110 may determine the change range of the zoom magnification based on the flight speed of the unmanned aerial vehicle 100. When the zoom magnification of the first photographing device 220 is increased, the view angle of the first photographing device 220 may increase, and an image closer to the subject to be photographed may be obtained. By increasing the zoom magnification during one shooting, the second image Gb may become an image that advances closer to the subject to be photographed, to emphasize and present the feeling of moving at high speed (high speed feeling). In one embodiment, the UAV controller 110 may store the information of the zoom magnification and the change range of the zoom magnification in the memory 160, or may store it in the memory 15 through the camera processor 11 of the first photographing device 220.

In one embodiment, the second image Gb may be photographed with an exposure time longer than the exposure time of the first image Ga, and may be denoted as a long-exposure image.

The UAV controller 110 may calculate the flight speed of the unmanned aerial vehicle 100. In one embodiment, the UAV controller 110 may calculate and obtain the flight speed of the unmanned aerial vehicle 100 by integrating the acceleration measured by the inertial measurement unit 250. In another embodiment, the UAV controller 110 may calculate and obtain the flight speed of the unmanned aerial vehicle 100 by performing a differential operation on the current position measured by the GPS receiver 240 at different times.

The UAV controller 110 may be configured to determine a mixing ratio for synthesizing the first image Ga and the second image Gb. The UAV controller 110 may be configured to determine a mixing ratio based on the flight speed of the unmanned aerial vehicle 100. The UAV controller 110 may be configured to synthesize the first image Ga and the second image Gb to generate the synthesized image according to the determined mixing ratio. An image range (an image size) of the first image Ga and an image range (an image size) of the second image Gb may be same (that is, may have a same size). Correspondingly, an image range (an image size) of the synthesized image may be a same image range (a same image size).

In one embodiment, in the synthesized image, a mixing ratio for each pixel in the synthesized image may be different. In another embodiment, in the synthesized image, for each region where a plurality of pixels of the synthesized image aggregates may have a different mixing ratio. In some other embodiments, for each pixel in a same region, the mixing ratio may be same or different.

In some embodiments, the UAV controller 110 may be configured to synthesize three or more images. The UAV controller 110 may use a method same as the above embodiments to determine a mixing ratio of each image for synthesizing the three or more images.

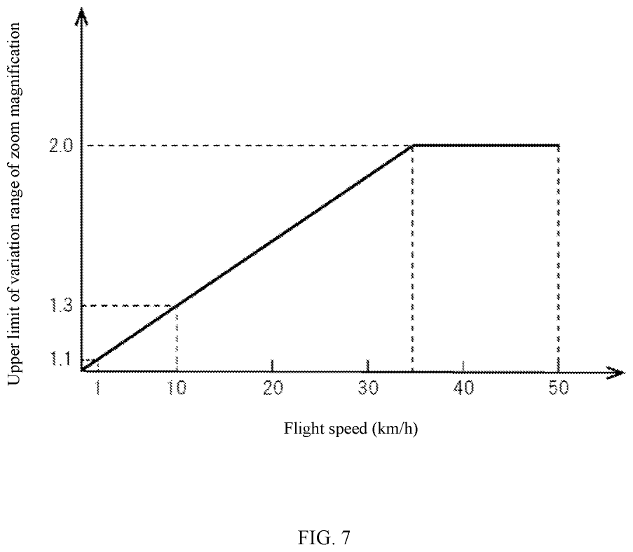

FIG. 7 illustrates a variation range of the zoom magnification with respect to the flight speed of the unmanned aerial vehicle 100 when photographing the second image Gb. The relationship illustrated in FIG. 7 can be apply to optical zoom, digital zoom, or optical zoom and digital zoom simultaneously. The information indicating the variation range of the zoom magnification with respect to the flight speed of the unmanned aerial vehicle 100 may be stored in the memory 160. For illustrative purposes only, the embodiment illustrated in FIG. 7, where a lower limit o the variation range of the zoom magnification is a zoom magnification 1.0, is used as an example, and should not limit the scope of the present disclosure. In various embodiments, another suitable value of the zoom magnification may be used as the lower limit of the variation range.

In FIG. 7, an upper limit of the variation range of the zoom magnification with respect to the flight speed is represented by a line. Specifically, in one embodiment, when the flight speed is 1 km/h, the upper limit of the zoom magnification may be a value of 1.1. In this scenario, the zoom magnification may vary from 1.0 to 1.1. When the flight speed is 10 km/h, the upper limit of the range of zoom magnification may be 1.3. In this scenario, the variation range of the zoom magnification may be 1.0 to 1.3. When the flight speed is 35 km/h, the upper limit of the variation range of the zoom magnification may be a value of 2.0 (an example of the maximum value of the upper limit). In this scenario, the variation range of the zoom magnification may be 1.0 to 2.0. When the flight speed is 50 km/h, the upper limit of the change range of the zoom magnification is also the maximum value of 2.0, and the corresponding variation range of the zoom magnification may be 1.0 to 2.0.

For illustrative purposes only, the embodiment illustrated in FIG. 7, where the maximum value of the upper limit of the variation range of the zoom magnification is 2.0, is used as an example to illustrate the present disclosure, and should not limit the scope of the present disclosure. In various embodiments, another suitable value of the zoom magnification may be used as the maximum value of the upper limit of the variation range. For illustrative purposes only, the embodiment illustrated in FIG. 7, where a variation of the upper limit of the variation range of the zoom magnification with respect to the flight speed is represented by a line, is used as an example, and should not limit the scope of the present disclosure. In various embodiments, a variation of the upper limit or the variation range of the zoom magnification with respect to the flight speed can be represented by any suitable curves including an S-shape curve.

In the present disclosure, by setting the upper limit of the variation range of the zoom magnification with respect to the flight speed, the zoom magnification may be higher when the flight speed of the unmanned aerial vehicle 100 is higher. That is, it may be configured to make of the variation range of the zoom magnification larger when the flight speed of the unmanned aerial vehicle 100 is higher. Correspondingly, the second image Gb may be plot such that a size of a subject to be photographed in the image may vary significantly with respect to the zoom magnification, and a high speed flying effect where the high speed feeling becomes more significant when the flight speed is higher ma be achieved.

In one embodiment, the maximum zoom magnification may be determined by the maximum magnification of optical zoom and digital zoom. For example, when the time (zoom time) required for the zoom action using the optical zoom in the first photographing device 220 is longer than the exposure time when the second image Gb is taken, the maximum zoom magnification may be limited by the zoom magnification which is achievable for the zoom action (movement of the lens barrel) in the exposure time. For example, if the mechanism for optical zoom operates at high speed, the variable range of the zoom magnification may become larger, and even if the variable range of the zoom magnification is large, the zoom action can follow.

The UAV controller 110 may determine the variation range of the zoom magnification for obtaining the second image Gb based on the flight speed of the unmanned aerial vehicle 100.

The unmanned aerial vehicle 100 can obtain the range of change of the zoom magnification based on the flight speed of the unmanned aerial vehicle 100, so the unmanned aerial vehicle 100 can determine the degree of flight speed that the image reflects. Therefore, the user can enjoy the high-speed feeling while being aware of the flight speed of the unmanned aerial vehicle 100 by viewing the image to which the high-speed flight effect is applied.

The unmanned aerial vehicle 100 may obtain the variation range of the zoom magnification based on the flight speed of the unmanned aerial vehicle 100, so the unmanned aerial vehicle 100 can determine the degree of flight speed that the image reflects. Therefore, the user can enjoy the high-speed feeling while being aware of the flight speed of the unmanned aerial vehicle 100 by viewing the image to which the high-speed flight effect is applied.

When the flight speed of the unmanned aerial vehicle 100 is larger, the variation range of the zoom magnification may be larger. Correspondingly, so that the proximity to the subject to be photographed in the second image Gb may appear to be higher. Therefore, the user can perceive the change in the zoom magnification through the synthesized image obtained by synthesizing the first image Ga and the second image Gb, and further can easily and intuitively obtain a high-speed feeling.

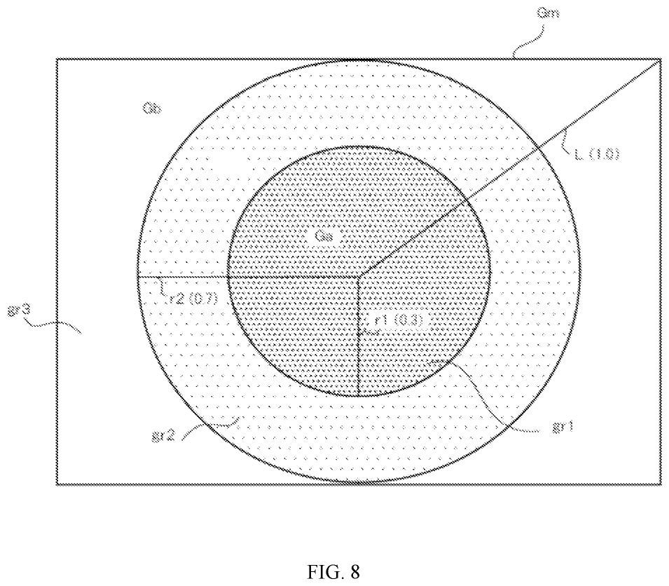

FIG. 8 illustrates an exemplary synthesized image Gm obtained by synthesizing two photographed images including the first image Ga and the second image Gb captured by the first photographing device 220.

The synthesized image Gm may include: a circular image area gr1, a ring-shape image area gr2, and an image region gr3 outside the image area gr2. The image area gr1 may be formed by a first radius r1 with the synthesized image as a center (an image center). The image area gr2 may be surrounded by an inner side of a circle with a second radius r2 and an outer side of a circle with the first radius r1, with image as a center. For example, in one embodiment, when a distance L from the center of the image to the corner of the synthesized image Gm is set to 1.0, a value of the first radius r1 may be 0.3, and a value of the second radius r2 may be 0.7. Further, these values are only examples, and the area in the synthesized image Gm may be formed with other values (ratio). The length of the first radius r1 and the second radius r2 may be determined according to the flight speed of the unmanned aerial vehicle 100.

The synthesized image Gm may be formed by synthesizing the first image Ga and the second image Gb with a certain mixing ratio. The mixing ratio may be represented by a ratio of the components of the second image Gb in each pixel of the synthesized image Gm. For example, in the image area gr1, the first image Ga may occupy 100%, and the image area gr1 may not include the components of the second image Gb. That is, the value of the mixing ratio in the image area gr1 may be 0.0. In the image area gr3, the second image Gb may occupy 100%. That is, the value of the mixing ratio in the image area gr2 may be 1.0. The image area gr2 may include the components of the first image Ga and the components of the second image Gb, and the value of the mixing ratio may be greater than 0.0 and less than 1.0.

That is, in the synthesized image Gm, the more the components of the second image Gb are, the higher is the mixing ratio. When all are the components of the second image Gb, the value of the mixing ratio becomes 1.0. On the other hand, in the synthesized image Gm, the less the components of the second image Gb are, that is, the more the components of the first image Ga are, the higher is the mixing ratio. When all are the components of the first image Ga, the value of the mixing ratio may become 0.0. For illustrative purposes only, the embodiment where the image regions gr1, gr2, and gr3 are divided by concentric circles is used as an example, and should not limit the scope of the present disclosure. In various embodiments, the image regions gr1, gr2, and gr3 may be divided by polygons including triangles and quadrangles, or other suitable shapes.

In one embodiment, from the center (image center) to the end of the synthesized image Gm, the synthesized image Gm may sequentially include: an image region gr1 (an example of the first region) which includes the components of the first image Ga but does not include the components of the second image Gb; an image area gr2 (an example of the second area) which includes the components of the first image Ga and the second image Gb; and an image area gr3 (an example of the third area) which does not include the components of the first image Ga but include the components of the second image Gb.

Correspondingly, the first image Ga captured at a fixed zoom magnification may be drawn in the image area gr1 near the center of the synthesized image Gm, so the subject to be photographed may be clearly drawn, and the user can easily recognize the subject. Also, since the enlarged second image Gb may be drawn in the image area gr3 near the end of the synthesized image Gm while changing the zoom magnification, the user can obtain a high-speed feeling. Also, since the components of the first image Ga and the second image Gb may be included between the image area gr1 and the image area gr3, the unmanned aerial vehicle 100 may smooth the transition between the image area gr1 and the image area gr3, and it is possible to provide the user with a synthesized image gm with reduced inharmonious feeling.

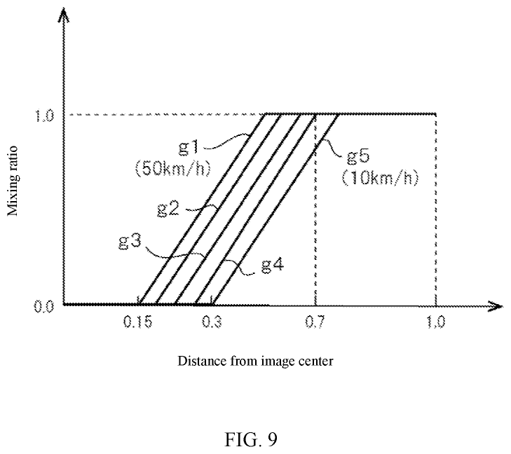

FIG. 9 illustrates a change of the mixing ratio with a change of a distance from the image center of the synthesized image Gm. The relationship between the mixing ratio and the radius may be stored in the memory 160. In the embodiment illustrated in FIG. 9, five images including g1, g2, g3, g4, and g5 are shown.

The five images including g1, g2, g3, g4, and g5 may be configured according to the flying velocity of the unmanned aerial vehicle 100. For example, the image g1 may correspond to a flight speed of 50 km/h, and the image g5 may correspond to a flight speed of 10 km/h.

In the images from g1 to g5, the value of the mixing ratio may be 0.0 (0%) in a range from the image center of the synthesized image Gm to a first radius r1 (corresponding to the image area gr1), that is, in the synthesized image Gm, the first image Ga may occupy 100%. In one embodiment, in the images g1 to g5, for example, the value of the first radius r1 may be set to 0.15 to 0.3.

In the images g1 to g5, in a range from the first radius r1 to a second radius r2 (corresponding to the image area gr2), it may be configured that when the distance from the image center of the synthesized image Gm is larger, the mixing ratio may be larger. For example, in the graph g1, the value of the mixing ratio may changes from 0.0 to 1.0 when the distance from the image center changes from a value of 0.15 to 0.55. The change in the mixing ratio with respect to the change in the distance from the image center in this interval may be represented by a straight line. The slope of the straight line may be set arbitrarily. In some other embodiments, the change in the mixing ratio with respect to the change in the distance from the image center may be expressed by a curve including an S-shaped curve.

In the images g1 to g5, in a range exceeding the second radius r2 (the range in which the distance from the center of the captured image is larger than the second radius r2, corresponding to the image area gr3), the value of the mixing ratio may be 1.0 (100%). That is, in the synthesized image Gm, the second image Gb may occupy 100%.

Correspondingly, in the image area gr2, the closer to the end of the image area gr1, the image with the higher ratio of the first image Ga may be obtained, and the closer to the end of the image area gr3, the image with the higher ratio of the second image Gb may be obtained. For example, it can be understood that in FIG. 9, in any one of the graphs g1 to 5, at the position corresponding to the change of the mixing rate of the image area gr2, it is a graph rising to the right. That is, the mixing ratio may be higher when a distance from the image center of the synthesized image Gm may be higher and the ratio of the second image Gb may be higher. Therefore, in the image area gr2, the closer to the end of the synthesized image Gm, the component of the second image Gb may be larger.

Further, in a region closer to the image center of the synthesized image Gm in the image area gr2, the image closer to the subject to be photographed in the real space may be obtained. In a region closer to the end of the synthesized image Gm, the high-speed flight effect may be stronger. Therefore, the unmanned aerial vehicle 100 may obtain a high-speed feeling while maintaining a state where it is easy to view the subject. Also, the unmanned aerial vehicle 100 can smoothly connect the image area gr1 and the image area gr3 without inharmonious feeling.

Further, in the synthesized image Gm, it may be that the image area gr1 is smaller and the image area gr3 is larger when the flight speed of the unmanned aerial vehicle 100 is larger. For example, with respect to the image g5 in FIG. 9 corresponding to a lower speed flight, the image area gr3 with a mixing ratio of 1.0 may be obtained at a position where the distance value from the image center is 0.75. With respect to image g1 corresponding to a higher speed flight, the image area gr3 with a mixing ratio of 1.0 may be obtained at a position where the distance value from the image center is 0.55.

Therefore, when the flight speed of the unmanned aerial vehicle 100 is high, the area of the first image Ga on which the clear subject is drawn may become smaller, and the same effect as when moving at high speed may be obtained. In addition, the image area gr3 with a high-speed feeling may become larger, so that it can be presented at a higher speed flying mode.

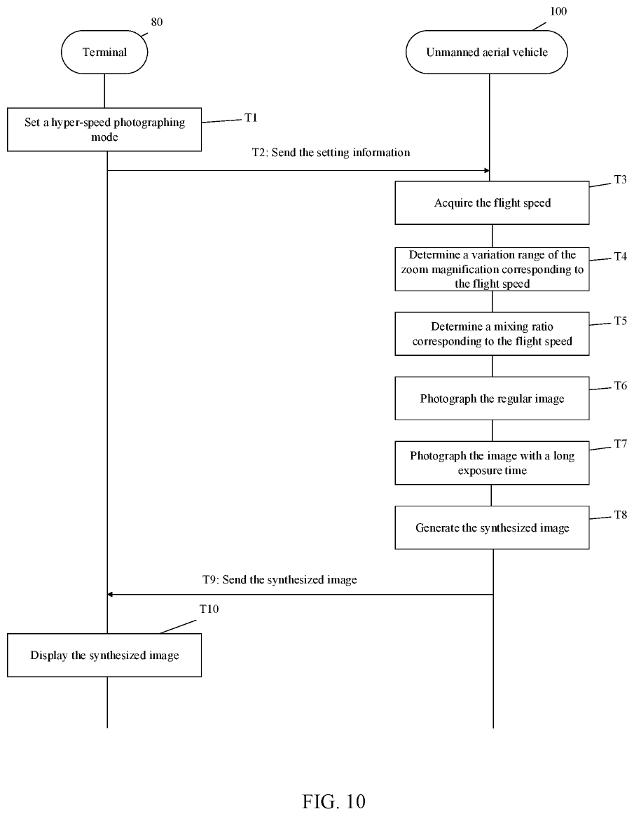

FIG. 10 illustrates a sequential diagram of the operation of the aerial object system 10. In FIG. 10, the unmanned aerial vehicle 100 is in the flying mode.

At the terminal 80, the terminal controller 81 sets the hyper-speed photographing mode when receiving an operation for setting the hyper-speed photographing mode from the user via the operation unit 83 (T1). The terminal controller 81 transmits setting information including the setting of the hyper-speed photographing mode to the unmanned aerial vehicle 100 via the communication circuit 85 (T2).

At the unmanned aerial vehicle 100, the UAV controller 110 may receive the setting information from the terminal 80 via the communication interface 150, set the hyper-speed photographing mode, and store the setting information in the memory 160. For example, the UAV controller 110 calculates and obtains the flight speed of the unmanned aerial vehicle 100 (T3).

The UAV controller 110 determines the zoom magnification corresponding to the flight speed based on the information stored in the memory 160, such as the image shown in FIG. 7 (T4). The UAV controller 110 further determines the change of the mixing ratio of various areas and various pixels in the synthesized image corresponding to the flight speed based on, e.g., the image shown in FIG. 9, stored in the memory 160 (T5). The UAV controller 110 may set the determined changes in zoom magnification and mixing ratio, and store them in the memory 160 and the memory 15.

The UAV controller 110 may control the first photographing device 220 to photograph. The camera processor 11 of the first photographing section 220 controls the shutter driver 19 to capture the first image Ga including the subject to be photographed (T6). The camera processor 11 may store the first image Ga in the memory 160.

The camera processor 11 controls the shutter driver 19, while performing a zoom operation based on the information including the change range of the zoom magnification stored in, e.g., the memory 15, to capture the second image Gb including the subject to be photographed (T7). The camera processor 11 may store the second image Gb in the memory 160.

The UAV controller 110 synthesizes the first image Ga and the second image Gb stored in the memory 160 according to the mixing ratio determined at T5 to generate the synthesized image Gm (T8).

In one embodiment, the change of the mixing ratio may be determined according to the flight speed before the photographing is started. In another embodiment, the UAV controller 110 may obtain the information of the flight speed sequentially. The UAV controller 110 may use the flight speed at T6 and T7 to determine the mixing ratio, or use an average of the flight speed when photographing at T6 and T7 to determine the mixing ratio.

The UAV controller 110 transmits the synthesized image Gm to the terminal 80 via the communication interface 150 (T9).

In the terminal 80, when the terminal controller 81 receives the synthesized image Gm from the unmanned aerial vehicle 100 via the communication circuit 85, the terminal controller 81 causes the display 88 to display the synthesized image Gm (T10).

At T8, two images including the first image Ga captured at T6 and the second image Gb captured at T7 may be used to generate the synthesized image Gm. In some other embodiments, the synthesized image Gm may be generated based on one captured image.

According to the processing in FIG. 10, the unmanned aerial vehicle 100 may generate an image that emphasizes the high-speed feeling more than the actual moving speed when photographed by the unmanned aerial vehicle 100, and may artificially present the high-speed feeling. Therefore, for example, even when the flying height of the unmanned aerial vehicle 100 is high and the feeling of high-speed flight is difficult to produce, an image in which the high-speed feeling is easily obtained can be generated.

Further, even when the unmanned aerial vehicle 100 is not flying, the unmanned aerial vehicle 100 may apply the above-mentioned high-speed movement effect to the photographed image captured by the unmanned aerial vehicle 100, thereby stimulatingly generating an image with the unmanned aerial vehicle 100 moving at a high speed.

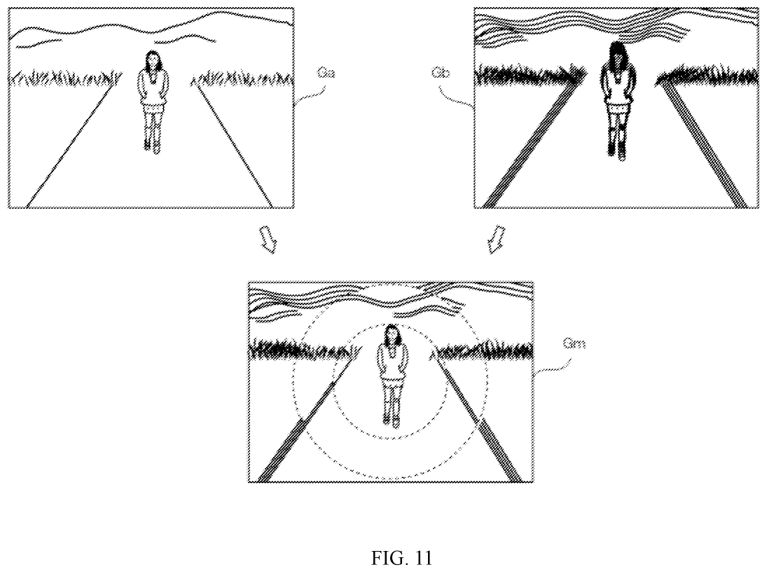

FIG. 11 illustrates an example of the first image Ga, the second image Gb, and the synthesized image Gm. The synthesized image Gm is an image whom the high-speed flying effect is applied.

For example, in one embodiment, the subject to be photographed may include people and backgrounds. The first image Ga may be a clear image where the subject to be photographed is relatively clear, and may flow with a speed corresponding to the flight speed of the unmanned aerial vehicle 100. The second image Gb may be an image captured while performing a zooming action, and may be an image with a visual effect of high-speed movement. Therefore, the second image Gb may be, for example, an image in which radial light streaks are placed around the subject to be photographed located at the image center of the second image Gb. The synthesized image Gm may be an image obtained by synthesizing the first image Ga and the second image Gb at a mixing ratio corresponding to the flight speed. Therefore, the synthesized image Gm may flow around the person (background) to quickly approach the image of the person located in the center of the image.

More specifically, in the synthesized image Gm, a region at the vicinity of the image center may be the same as the first image Ga, a region at the vicinity of the image end may be the same as the second image Gb, and a region between the image center and the vicinity of the image end may be an image including a mixture of the components of the first image Ga and the second image Ga. Correspondingly, the synthesized image Gm is a sharp image near the center of the image, such that it may be easy to understand what kind of subject is being drawn. Also, since the synthesized image Gm is an image in which the zoom magnification changes near the end of the image, that is, an image including image components of multiple zoom magnifications, it can present a high-speed feeling and a sense of reality to users viewing the synthesized image Gm.

Correspondingly, in the unmanned aerial vehicle 100, the UAV controller 110 may obtain the flight speed (an example of the moving speed) of the unmanned aerial vehicle 100. The first photographing device 220 may capture and obtain the first image Ga (an example of the first image) with a fixed zoom magnification. The first photographing device 220 may capture a second image Gb (an example of a second image) in which the first image Ga (a subject to be photographed captured in the first image Ga) is enlarged while changing the zoom magnification. The UAV controller 110 may determine the mixing ratio (an example of the synthesizing ratio) for synthesizing the first image Ga and the second image Gb based on the flight speed of the unmanned aerial vehicle 100. The UAV controller 110 may synthesize the first image Ga and the second image Gb based on the determined mixing ratio to generate the synthesized image Gm.

In the present disclosure, the unmanned aerial vehicle 100 may use the images taken by the unmanned aerial vehicle 100 to easily obtain an image with a high-speed movement effect. Therefore, for example, the user may not need to manually operate a PC while applying an effect, and may not need to edit the image while finely adjusting the position of the subject before and after the movement to obtain an image with a high-speed movement effect. Correspondingly, unmanned aerial vehicle 100 can reduce the cumbersome operation of the user, and can also reduce the error operation.

The UAV controller 110 may photograph and obtain the second image Gb when changing the zoom magnification of the first photographing device 220.

Correspondingly, the image of the real space photographed by the unmanned aerial vehicle 100 may be used as the second image Gb. A processing load of the unmanned aerial vehicle 100 for obtaining the second image Gb may be reduced, for example, in comparison with a case where the second image Gb is generated by calculation.

Further, the UAV controller 110 may use the first photographing device 220 to capture the second image Gb using the exposure time t2 (an example of the second exposure time) for capturing the second image Gb larger than the exposure time t1 (an example of the first exposure time) for capturing the first image Ga. That is, the second image Gb may be a long-time exposure image. Thus, the unmanned aerial vehicle 100 can ensure the time for changing the zoom magnification during the shooting of the second image Gb by extending the exposure time of the second image Gb that mainly contributes to the high-speed movement effect. Therefore, for example, even when the optical zoom is used in the zoom operation, the unmanned aerial vehicle 100 may easily capture the second image Gb while the zoom magnification desired by the user is changed.

The present disclosure also provides a synthesized image generation method based on one image.

In embodiments illustrated in FIG. 10, a plurality of photographed images (for example, the first image Ga and the second image Gb) are used as the photographed images. In some other embodiments, a synthesized image Gm may be generated based on one photographed image (for example, the first image Ga). The UAV controller 110 may generate a plurality of images in which the first image Ga is enlarged at different zoom magnifications. The UAV controller 110 may crop the plurality of enlarged images to a predetermined size to generate a plurality of cropped images, and then synthesize the plurality of cropped images to generate the second image Gb. In one embodiment, the second image Gb may be generated, for example, by averaging the pixel values of the plurality of cropped images. Then, the UAV controller 110 may synthesize the first image Ga obtained by photographing and the second image Gb obtained by calculation to generate the synthesized image Gm.

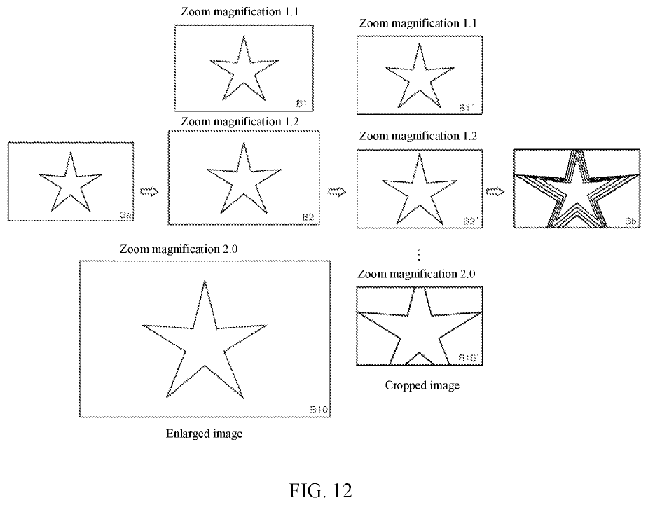

FIG. 12 illustrates an example of generating the synthesized image Gm based on one photographed image.

As illustrated in FIG. 12, the UAV controller 110 generates ten enlarged images B1 to B10 based on one first image Ga. In some embodiments, the UAV controller 110 may set the zoom magnification to 1.1 to generate an enlarged image B1 that magnifies the captured image A by 1.1 times, and set the zoom magnification to 1.2 to generate an enlarged image B2 that magnifies the captured image A by 1.2 times, and so on, and set the zoom magnification to 2.0 to generate an enlarged image B10 that enlarges the captured image A by 2.0 times.

For illustrative purposes only, the above embodiment with specified zoom magnification is used as an example and should not limit the scope of the present disclosure. In various embodiments, each zoom magnification may have any suitable value. In some embodiment, the zoom magnification may change by various difference values instead of a specified difference.

The UAV control section 110 may crop out a portion from each of the enlarged images B1 to B10 with as size same as the photographed image A to include the main subject, and generate cropped images BP to B10′. The UAV controller 110 may synthesize the cropped images BP to B10′ to generate a second image Gb. In this embodiment, the UAV controller 110 may generate the second image Gb by adding and averaging corresponding pixel values of the cropped images BP to B10′. Therefore, the second image Gb obtained by calculation may be an image that can obtain a high-speed feeling similar to the captured image, to approach the main subject while changing the zoom magnification by one shot.

In FIG. 12, the unmanned aerial vehicle 100 in FIG. 7 has a flight speed of about 35 km/h and 50 km/h. Correspondingly, the second image Gb generated in FIG. 12 has an effect same as the second image photographed when changing the zoom magnification from 1.0 to 2.0.

In the present disclosure, the UAV control section 110 may generate the plurality of cropped images B1′ to B10′ (an example of the third image) obtained by zooming in at a plurality of different zoom magnifications and cropping the first image Ga, and synthesize the plurality of cropped images BP to B10′ to generate the second image Gb.

Therefore, the first photographing device 220 may only need to photograph once, and therefore the imaging burden of the first photographing device 220 may be reduced. In other words, instead of capturing the second image Gb by the first photographing device 220, the image may be processed based on the first image Ga to generate the second image Gb. Further, after the first image Ga is captured once, the unmanned aerial vehicle 100 may not move. When the unmanned aerial vehicle 100 is in a stopped state, an image with a high-speed feeling may be generated as the synthesized image Gm.

The present disclosure also provides a computer-readable storage medium. Computer programs may be stored in the computer-readable storage medium. When the programs are executed by a processor, the feedback method of status of a photography device described above may be achieved.

Those of ordinary skill in the art will appreciate that the example elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

For simplification purposes, detailed descriptions of the operations of example systems, devices, and units may be omitted and references can be made to the descriptions of the example methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be synthesized or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processor, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the example methods described above. The storage medium can be any medium that can store program codes, for example, a USB disk, a mobile hard disk, a read-only memory (ROM), a random access memory (RAM), a magnetic disk, or an optical disk.

In the various embodiments of the present disclosure, the unmanned aerial vehicle is used as an example of the movable body, and should not limit the scope of the present disclosure. In some other embodiments, the content of the present disclosure may be also applied, but not limited to an unmanned car with a camera, a bicycle with a camera, or a gimbal with a camera held by people while moving.

The execution order of the actions, sequences, steps, and stages in the devices, systems, programs, and methods shown in the claims, specifications, and drawings may be implemented in any order, as long as there is no special indication such as “before” or “in advance”,” and as long as the output of the previous processing is not used in the subsequent processing. Regarding the operating procedures in the claims, the specification and the drawings, the descriptions are made using “first”,” “next”,” etc. for convenience, but it does not mean that it must be implemented in this order.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A movable body comprising:
a photographing device; and
a processor configured to:
obtain a moving speed of the movable body;
instruct the photographing device to photograph a first image of a scene with a zoom magnification of the photographing device being fixed;
obtain a second image of the scene with a varying zoom magnification larger than the fixed zoom magnification used for photographing the first image;
determine a mixing ratio of the first image and the second image according to the moving speed of the movable body; and
synthesize the first image and the second image based on the mixing ratio to generate a synthesized image.

2. The movable body according to claim 1, wherein the processor is further configured to instruct the photographing device to photograph the second image while changing the zoom magnification of the photographing device.

3. The movable body according to claim 2, wherein the processor is configured to instruct the photographing device to:
photograph the first image using a first exposure time; and
photograph the second image using a second exposure time longer than the first exposure time.

4. The movable body according to claim 1, wherein the processor is further configured to:
generate a plurality of third images of the scene corresponding to different values of the zoom magnification that are larger than the fixed zoom magnification used for photographing the first image; and
synthesize the plurality of third images to generate the second image.

5. The movable body according to claim 1, wherein the processor is further configured to determine a variation range of the zoom magnification for obtaining the second image according to the moving speed of the movable body.

6. The movable body according to claim 5, wherein the variation range of the zoom magnification is positively correlated to the moving speed of the movable body.

7. The moving according to claim 1, wherein:
the synthesized image includes a first region, a second region, and third region sequentially from a center of the synthesized image to an edge of the synthesized image;
the first region includes components of the first image and does not include components of the second image;
the second region includes the components of the first image and the components of the second image; and
the third region does not include the components of the first image and includes the components of the second image.

8. The movable body according to claim 7, wherein, in the second region, an amount of the components of the second image increases with increasing distance from the center of the synthesized image.

9. The movable body according to claim 7, wherein, in the synthesized image, an area of the first region is negatively correlated to the moving speed of the movable body and an area of the third region is positively correlated to the moving speed of the movable body.

10. An image generation method comprising:
obtaining a moving speed of a movable body;
photographing, through a photographing device of the movable body, a first image of a scene with a zoom magnification of the photographing device being fixed;
obtaining a second image of the scene with a varying zoom magnification larger than the fixed zoom magnification used for photographing the first image;
determining a mixing ratio of the first image and the second image according to the moving speed of the movable body; and
synthesizing the first image and the second image based on the mixing ratio to generate a synthesized image.

11. The method according to claim 10, wherein obtaining the second image includes photographing the second image while changing the zoom magnification of the photographing device.

12. The method according to claim 11, wherein:
photographing the first image includes photographing the first image using a first exposure time; and
obtaining the second image includes photographing the second image using a second exposure time longer than the first exposure time.

13. The method according to claim 10, wherein obtaining the second image includes:
generating a plurality of third images of the scene corresponding to different values of the zoom magnification that are larger than the fixed zoom magnification used for photographing the first image; and
synthesizing the plurality of third images to generate the second image.

14. The method according to claim 10, wherein obtaining the second image includes determining a variation range of the zoom magnification for obtaining the second image according to the moving speed of the movable body.

15. The method according to claim 14, wherein the variation range of the zoom magnification is positively correlated to the moving speed of the movable body.

16. The method according to claim 10, wherein:
the synthesized image includes a first region, a second region, and third region sequentially from a center of the synthesized image to an edge of the synthesized image;
the first region includes components of the first image and does not include components of the second image;
the second region includes the components of the first image and the components of the second image; and
the third region does not include the components of the first image and includes the components of the second image.

17. The method according to claim 16, wherein, in the second region, an amount of the components of the second image increases with increasing distance from the center of the synthesized image.

18. The method according to claim 16, wherein, in the synthesized image, an area of the first region is negatively correlated to the moving speed of the movable body and an area of the third region is positively correlated to the moving speed of the movable body.

19. A computer-readable storage medium storing a program that, when executed by a processor, causes the processor to:
obtain a moving speed of a movable body;
photograph, through a photographing device of the movable body, a first image of a scene with a zoom magnification of the photographing device being fixed;
obtain a second image of the scene with a varying zoom magnification larger than the fixed zoom magnification used for photographing the first image;
determine a mixing ratio of the first image and the second image according to the moving speed of the movable body; and
synthesize the first image and the second image based on the mixing ratio to generate a synthesized image.
